(19) United States
(12) Patent Application Publication
(10) Pub. No.: US 2023/0090082 A1
(43) Pub. Date: Mar. 23, 2023

(54) SMOKESTACK INCLINATION DETECTION DEVICE, SMOKESTACK INCLINATION DETECTION METHOD, AND STORAGE MEDIUM

(71) Applicant: NEC Corporation, Minato-ku, Tokyo (JP)

(72) Inventor: Takahiro ONO, Tokyo (JP)

(73) Assignee: NEC Corporation, Minato-ku, Tokyo (JP)

(21) Appl. No.: 17/802,007

(22) PCT Filed: Mar. 18, 2021
(86) PCT No.: PCT/JP2021/011270

§ 371 Date: Aug. 24, 2022

(30) Foreign Application Priority Data
Mar. 18, 2020 (JP) 2020-047228

(51) Int. Cl. G01B 11/16; G01B 11/26; G01S 7/4861; G01S 17/10

(52) U.S. Cl. CPC G01B 11/16; G01B 11/26; G01S 7/4861; G01S 17/10

(57) ABSTRACT

In order to detect inclination of a smokestack, a smokestack inclination detection device 100D comprises an information generation unit 13 and an inclination detection unit 15. The information generation unit 13 generates smokestack shape information on the basis of reflected laser light. The reflected laser light refers to light resulting from laser light illuminated on the smokestack and reflected by the smokestack. The smokestack shape information refers to information about the shape of the smokestack. The inclination detection section 15 detects the inclination of the smokestack on the basis of the smokestack shape information generated by the information generation unit 13.

### TECHNICAL FIELD

The present invention relates to a smokestack inclination detection device and the like, for example, relates to a technique of a smokestack inclination detection device and the like that detect inclination of a smokestack.

### BACKGROUND ART

PTL 1 discloses a corrosion scanning system that detects presence or absence of corrosion, a dent, and a defect in a surface.

The corrosion scanning system includes a positioning arm, a laser device, and a computer-readable means. The laser device is mounted to an end portion of the positioning arm. The positioning arm is able to three-dimensionally move the laser device mounted to the end portion. The laser device is arranged in a vicinity of a surface of a target such as a smokestack, by movement of the positioning arm. The laser device applies laser light to a region of the surface, detects reflected laser light thereof, and thereby acquires surface state data. The computer-readable means receives, from the laser device, the surface state data acquired by the laser device, processes the pieces of data, and generates data relating to corrosion on a region of a measurement surface. Herein, the computer-readable means regards, as a corroded part, a part having a difference being equal to or more than a threshold value in comparison with criterion data.

In this way, the invention described in PTL 1 is able to detect corrosion of a surface of a smokestack or the like.

A technique being related to the present invention is also disclosed in each of PTLs 2 and 3.

### CITATION LIST

### Patent Literature

[PTL 1] Japanese Unexamined Patent Application Publication

(Translation of PCT Application) No. 2006-519369

[PTL 2] Japanese Unexamined Patent Application Publication No. H07-270133

[PTL 3] Japanese Unexamined Patent Application Publication No. H05-322778

### SUMMARY OF INVENTION

### Technical Problem

However, the invention described in PTL 1 has a problem that, while corrosion of a surface of a smokestack or the like can be detected, the invention is not able to recognize inclination of the smokestack.

The present invention has been made in view of such a situation, and an object of the present invention is to provide a smokestack inclination detection device and the like that are able to detect inclination of a smokestack.

### Solution to Problem

A smokestack inclination detection device according to the present invention includes an information generation means for generating smokestack shape information being information relating to a shape of a smokestack, based on reflected laser light being light resulting from laser light illuminated on the smokestack and reflected by the smokestack, and an inclination detection means for detecting inclination of the smokestack, based on the smokestack shape information generated by the information generation means.

A smokestack inclination detection system according to the present invention is a smokestack inclination detection system including a light source and a smokestack inclination detection device, wherein the light source means includes a light illumination means for illuminating laser light on a smokestack, a light receiving means for receiving reflected laser light being light resulting from the laser light reflected by the smokestack, and an information generation means for generating smokestack shape information being information relating to a shape of the smokestack, based on the reflected laser light received by the light receiving means, and the smokestack inclination detection device includes an inclination detection means for detecting inclination of the smokestack, based on the smokestack shape information generated by the information generation means.

A smokestack inclination detection method according to the present invention includes generating smokestack shape information being information relating to a shape of a smokestack, based on reflected laser light being light resulting from laser light illuminated on the smokestack and reflected by the smokestack, and detecting inclination of the smokestack, based on the smokestack shape information.

A storage medium according to the present invention stores a program that causes a computer to execute processing including an information generation step of generating smokestack shape information being information relating to a shape of a smokestack, based on reflected laser light being light resulting from laser light illuminated on the smokestack and reflected by the smokestack, and a smokestack inclination detection step of detecting inclination of the smokestack, based on the smokestack shape information.

### Advantageous Effects of Invention

The present invention enables detection of inclination of a smokestack.

### BRIEF DESCRIPTION OF DRAWINGS

FIG. 1 is a block diagram illustrating a configuration of a smokestack inclination detection system according to a first example embodiment of the present invention.

FIG. 2 is a schematic diagram illustrating a first operation example of the smokestack inclination detection system according to the first example embodiment of the present invention.

FIG. 3 is a diagram illustrating one example of smokestack shape information.

FIG. 4 is a front transmission diagram illustrating a structure of a light source unit.

FIG. 5 is a top transmission diagram illustrating a structure of the light source unit, and is a diagram illustrating a configuration in an arrow-A view of FIG. 4.

FIG. 6 is a frontal transmission diagram illustrating a structure of the light source unit, and is a diagram illustrating a configuration in an arrow-B view of FIG. 4.

FIG. 7 is a front transmission diagram illustrating a structure of the light source unit, and is a diagram for describing an operation of causing laser light to scan.

FIG. 8 is a diagram for describing processing of deriving inclination of a smokestack.

FIG. 9 is a diagram illustrating an operation flow of the smokestack inclination detection system according to the first example embodiment of the present invention.

FIG. 10 is a schematic diagram illustrating a second operation example of the smokestack inclination detection system according to the first example embodiment of the present invention.

FIG. 11 is a block diagram illustrating a configuration of a smokestack inclination detection system according to a second example embodiment of the present invention.

FIG. 12 is a diagram illustrating an operation flow of the smokestack inclination detection system according to the second example embodiment of the present invention.

FIG. 13 is a block diagram illustrating a configuration of a smokestack inclination detection device according to a third example embodiment of the present invention.

FIG. 14 is a schematic diagram illustrating an operation example of the smokestack inclination detection device according to the third example embodiment of the present invention.

FIG. 15 is a diagram illustrating an operation flow of the smokestack inclination detection device according to the third example embodiment of the present invention.

FIG. 16 is a diagram illustrating a configuration of a smokestack inclination detection device according to a fourth example embodiment of the present invention.

FIG. 17 is a diagram illustrating an operation flow of the smokestack inclination detection device according to the fourth example embodiment of the present invention.

FIG. 18 is a diagram illustrating a configuration of a smokestack inclination detection device according to a fifth example embodiment of the present invention.

FIG. 19 is a diagram illustrating an operation flow of the smokestack inclination detection device according to the fifth example embodiment of the present invention.

### EXAMPLE EMBODIMENT

### First Example Embodiment

A smokestack inclination detection system 1000 according to a first example embodiment of the present invention is described, based on the drawings.

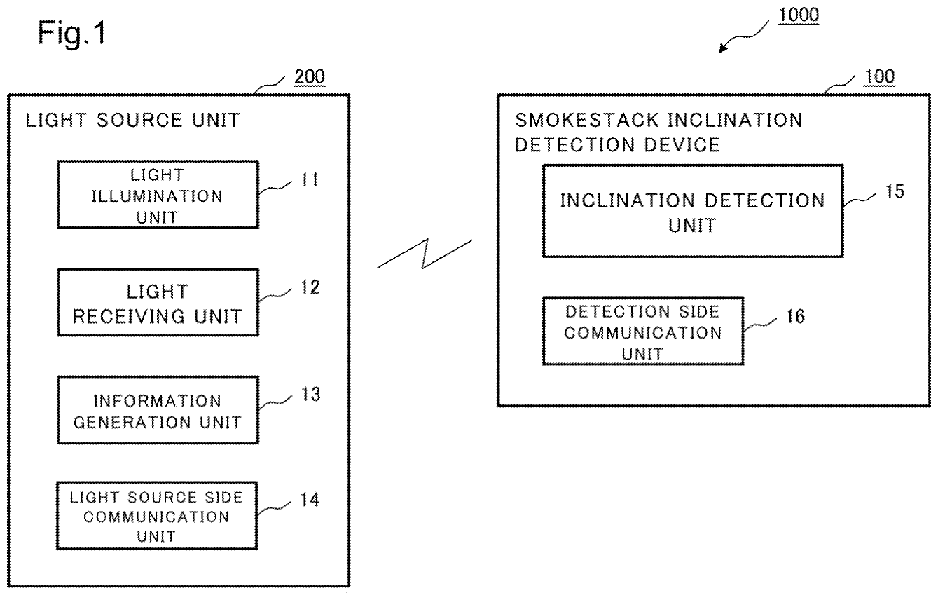

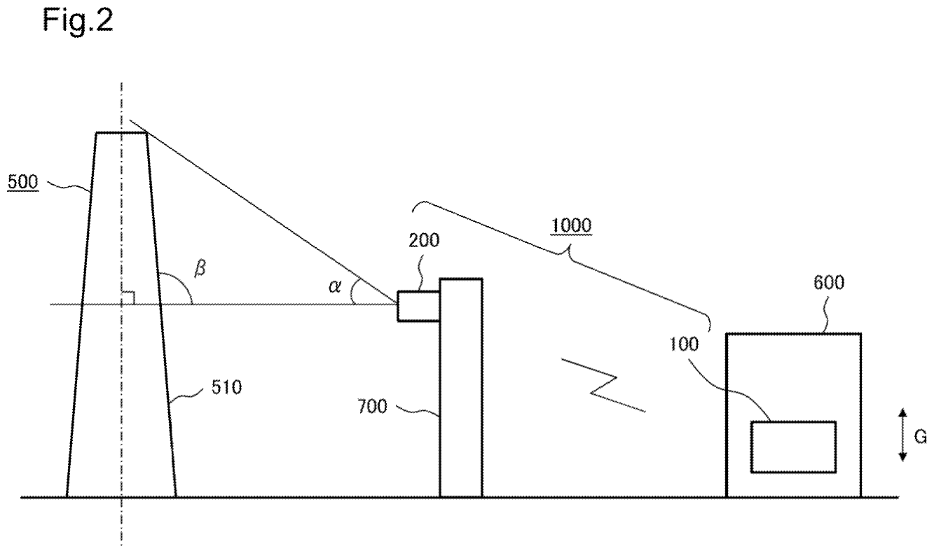

FIG. 1 is a block diagram illustrating a configuration of the smokestack inclination detection system 1000. FIG. 2 is a schematic diagram illustrating a first operation example of the smokestack inclination detection system 1000. A vertical direction G is indicated in FIG. 2.

Referring to FIG. 1, the smokestack inclination detection system 1000 includes a smokestack inclination detection device 100 and a light source unit 200.

Referring to FIG. 2, the smokestack inclination detection device 100 is provided in a data center 600. The smokestack inclination detection device 100 is not limited to be provided in the data center 600, and may be placed in such a place as an indoor or outdoor place.

The light source unit 200 is mounted on a support 700. The support 700 is, for example, a power pole, a pole for a light, a pole for a traffic signal, or the like. The light source unit 200 is not limited to be mounted on the support 700, and may be mounted to, for example, a steel tower, a tower, a building, or the like.

The light source unit 200 is arranged in such a way as to face a side surface 510 of a smokestack 500. More specifically, the light source unit 200 is arranged in such a way that laser light illuminated by the light source unit 200 is applied to the side surface 510 of the smokestack 500. A distance between the light source unit 200 and the smokestack 500 is generally 10 m to 500 m. However, a distance between the light source unit 200 and the smokestack 500 is not limited to 10 m to 500 m.

Next, with reference to FIGS. 1 and 2, a specific configuration is described, regarding each of the smokestack inclination detection device 100 and the light source unit 200.

For convenience of description, first, a configuration of the light source unit 200 is described. Referring to FIG. 1, the light source unit 200 includes a light illumination unit 11, a light receiving unit 12, an information generation unit 13, and a light source side communication unit 14. Herein, a technique of light detection and ranging (LiDAR) or laser imaging detection and ranging can be used for the light source unit 200. LiDAR is one of remote sensing techniques using light. The technique of LiDAR can measure scattered light against laser illumination emitted in a pulse form, and analyze a distance up to a target at a great distance, or a property of the target. LiDAR is similar to radar, and is a replacement of an electric wave of radar with light. A distance up to a target can be derived by a difference of time up to reception of reflected light after light emission.

The light illumination unit 11 illuminates laser light on the side surface 510 of the smokestack 500. More specifically, the light illumination unit 11 illuminates laser light in a single pulse form (single-pulse laser light) on the side surface 510 of the smokestack 500. Herein, for laser light, collimated light can be used, for example, with a wavelength being around 1400 to 1600 nm, and average output strength being around 10 to 20 dBm.

The light receiving unit 12 receives reflected laser light. The reflected laser light is light resulting from laser light illuminated on the smokestack 500 and reflected by the smokestack 500. Particularly, the reflected laser light is light resulting from laser light illuminated on the side surface 510 of the smokestack 500 and reflected by the side surface 510 of the smokestack 500.

The information generation unit 13 generates smokestack shape information, based on the reflected laser light received by the light receiving unit 12. Herein, the smokestack shape information is information relating to a shape of the side surface 510 of the smokestack 500.

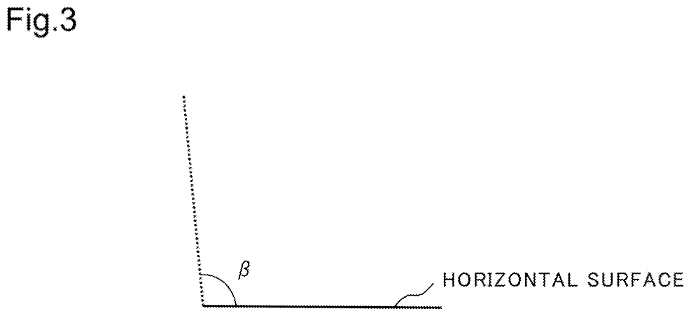

FIG. 3 is a diagram illustrating one example of smokestack shape information. Herein, the smokestack shape information is an angle β between the side surface 510 of the smokestack 500 and a horizontal surface (a surface perpendicular to the vertical direction G). A specific generation method of the smokestack shape information is described in detail later.

The light source side communication unit 14 transmits, to a detection side communication unit 16 of the smokestack inclination detection device 100, smokestack shape information generated by the information generation unit 13. A communication between the detection side communication unit 16 and the light source side communication unit 14 is performed in a wired or wireless way.

The configuration of the light source unit 200 has been described above.

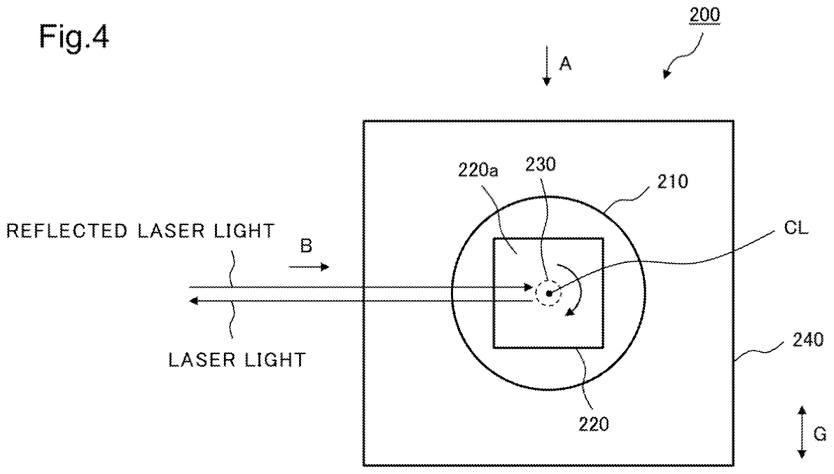

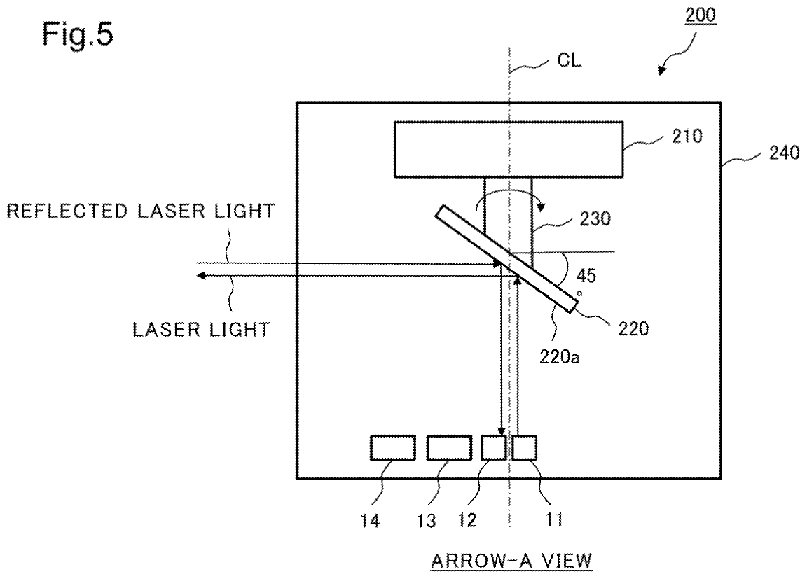

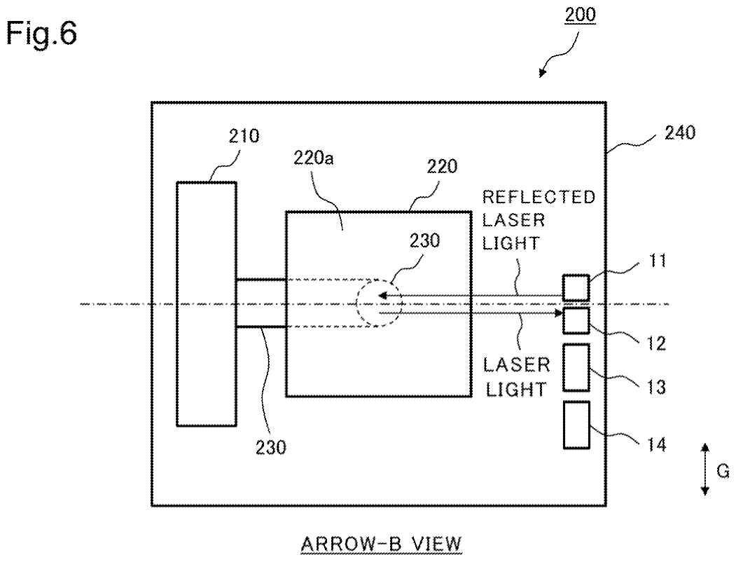

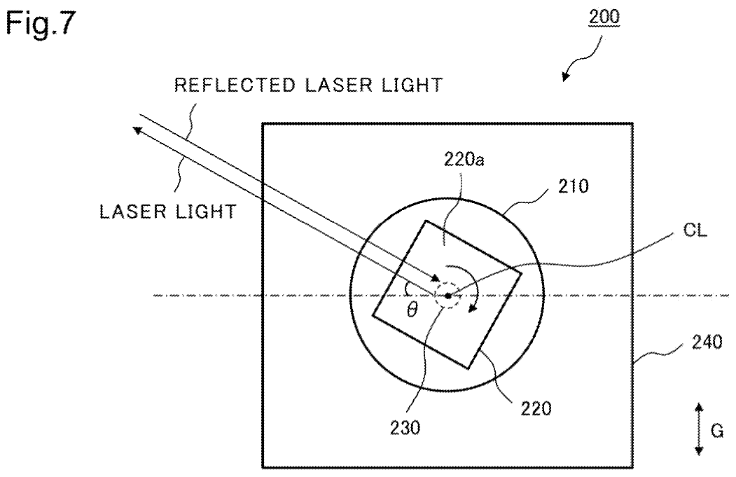

Next, a physical structure of the light source unit 200 is described. FIG. 4 is a front transmission diagram illustrating a structure of the light source unit 200. FIG. 5 is a top transmission diagram illustrating a structure of the light source unit 200, and is a diagram illustrating a configuration in an arrow-A view of FIG. 4. FIG. 6 is a frontal transmission diagram illustrating a structure of the light source unit 200, and is a diagram illustrating a configuration in an arrow-B view of FIG. 4. FIG. 7 is a front transmission diagram illustrating a structure of the light source unit 200, and is a diagram for describing an operation of causing laser light to scan. FIG. 7 is a diagram transmitting the light source unit 200 in the same direction as FIG. 4. The vertical direction G is indicated in FIGS. 4, 6, and 7.

Referring to FIGS. 4 to 6, the light source unit 200 includes a drive unit 210, a mirror 220, a rotation shaft 230, and a housing 240, in addition to the light illumination unit 11, the light receiving unit 12, the information generation unit 13, and the light source side communication unit 14.

The drive unit 210 is, for example, an electric motor, and rotates the mirror 220 about a central axis CL. The rotation shaft 230 is mounted to the drive unit 210.

The mirror 220 is fixed to the rotation shaft 230 in such a way that a reflection surface 220a of the mirror 220 always forms an angle of 45° to the central axis CL. A central portion of the mirror 220 is arranged in such a way as to face the light illumination unit 11 and the light receiving unit 12. The light illumination unit 11 and the light receiving unit 12 are arranged in such a way as to adjoin each other. The mirror 220 is arranged in such a way as to face the side surface 510 of the smokestack 500 at an angle of 45°.

Further, the mirror 220 reflects, in a direction of 90°, laser light illuminated by the light illumination unit 11. More specifically, the reflection surface 220a of the mirror 220 reflects, toward a direction perpendicular to the central axis CL, laser light illuminated by the light illumination unit 11.

The reflection surface 220a of the mirror 220 reflects, in a direction of 90°, reflected laser light from the side surface 510 of the smokestack 500. As described above, reflected laser light is light resulting from laser light illuminated on the smokestack 500 and reflected by the smokestack 500. More specifically, the reflection surface 220a of the mirror 220 reflects, toward the light receiving unit 12 along a direction of the central axis CL, reflected laser light from the side surface 510 of the smokestack 500. Thereby, reflected light of the laser light from the side surface 510 of the smokestack 500 enters the light receiving unit 12.

Herein, in FIGS. 4 to 7, for convenience of drawing preparation, light paths of laser light and reflected laser light are indicated away from each other. However, actually, light paths of laser light and reflected laser light are basically set in such a way as to overlap each other. Note that, laser light is in a single pulse form, and therefore does not interfere with reflected laser light. Even when laser light is not in a single pulse form but is in a continuous pulse form, laser light and reflected laser light can be inhibited from interfering with each other, by using an optical circulator. It is known that there are 3-port type and 4-port type optical circulators. In the 3-port type, light entering a port 1 exits from a port 2, and light entering the port 2 exits from a port 3. In the 4-port type, light entering a port 1 exits from a port 2, light entering the port 2 exits from a port 3, light entering the port 3 exits from a port 4, and light entering the port 4 exits from the port 1. Therefore, for example, when the 3-port type is used, transmission and reception of light can be performed even for continuous pulsed light without interfering on the same optical axis, by connecting the light illumination unit 11 to the port 1, connecting an output toward the smokestack 500 to the port 2, and connecting the light receiving unit 12 to the port 3.

The rotation shaft 230 couples the drive unit 210 and the mirror 220. The rotation shaft 230 rotates about the central axis CL by power of the drive unit 210. Thereby, the mirror 220 mounted to the rotation shaft 230 rotates about the central axis CL. FIG. 7 illustrates a state where the mirror 220 has rotated θ by rotation of the rotation shaft 230.

The housing 240 houses the light illumination unit 11, the light receiving unit 12, the information generation unit 13, the light source side communication unit 14, the drive unit 210, the mirror 220, and the rotation shaft 230. The housing 240 is formed of, for example, a metal such as aluminum or an aluminum alloy, or resin such as acrylonitrile butadiene styrene (ABS) synthetic resin. The light illumination unit 11, the light receiving unit 12, the information generation unit 13, and the light source side communication unit 14 are mounted to an inner surface or the like of the housing 240. For convenience of drawing preparation, the light illumination unit 11, the light receiving unit 12, the information generation unit 13, and the light source side communication unit 14 are schematically illustrated in each figure. Therefore, the arrangement relation of the light illumination unit 11, the light receiving unit 12, the information generation unit 13, and the light source side communication unit 14 is not precisely correct in each figure.

Herein, the central axis CL is set perpendicular to the vertical direction G. Further, as illustrated in FIG. 4, in initial setting, the reflection surface 220a of the mirror 220 is set in such a way as to reflect, in a direction perpendicular to the vertical direction G, laser light illuminated by the light illumination unit 11. Similarly, in initial setting, the reflection surface 220a of the mirror 220 is set in such a way that reflected laser light from the side surface 510 of the smokestack 500 enters in a direction perpendicular to the vertical direction G. Specifically, the arrangement relations are set when the light source unit 200 is mounted to the support 700 or the like. Note that a light source unit 20 may be configured in such a way that an adjustment can be always made to the above-described arrangement relation by use of a gyro sensor (angular velocity sensor).

In this way, by rotating the mirror 220 about the central axis CL by driving of the drive unit 210, laser light illuminated by the light illumination unit 11 can be caused to scan along the vertical direction G. Since the smokestack 500 is placed in such a way as to extend along the vertical direction G, laser light illuminated by the light illumination unit 11 can be caused to scan along an extension direction of the side surface 510 of the smokestack 500. Light (reflected laser light) resulting from laser light that is caused to scan along the extension direction of the side surface 510 of the smokestack 500 and reflected by the side surface 510 of the smokestack 500 sequentially enters the light receiving unit 12.

The physical structure of the light source unit 200 has been described above.

Next, a configuration of the smokestack inclination detection device 100 is described. Referring to FIG. 1, the smokestack inclination detection device 100 includes the inclination detection unit 15 and the detection side communication unit 16.

The inclination detection unit 15 detects inclination of the smokestack 500, based on smokestack shape information generated by the information generation unit 13. Herein, for example, the inclination detection unit 15 detects inclination of the smokestack 500, based on smokestack shape information generated by the information generation unit 13, and smokestack criterion information. The smokestack criterion information is criterion information relating to a shape of the smokestack 500. The smokestack criterion information is, for example, information relating to a shape of the smokestack 500 at a time of placing the smokestack 500. Alternatively, the smokestack criterion information is, for example, information relating to a past shape of the smokestack 500 several years ago. Herein, specifically, the smokestack criterion information is outer shape information of the smokestack 500. Further, more specifically, the smokestack criterion information is criterion information of the angle β between the side surface 510 of the smokestack 500 and a horizontal surface (a surface perpendicular to a vertical direction).

As described above, the smokestack shape information is the angle β between the side surface 510 of the smokestack 500 and a horizontal surface (a surface perpendicular to a vertical direction).

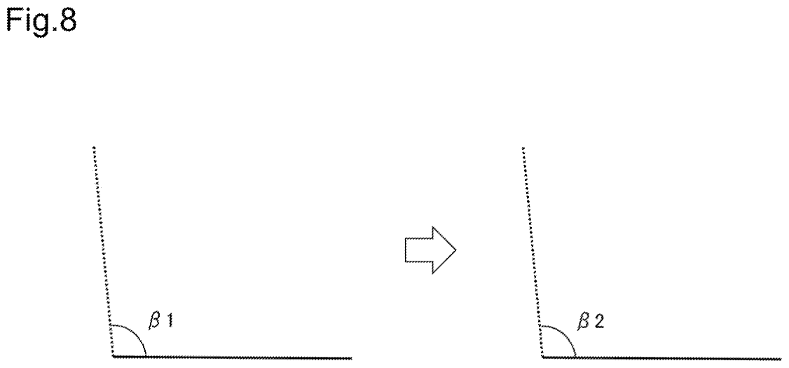

FIG. 8 is a diagram for describing processing of deriving inclination of the smokestack 500. Referring to FIG. 8, it is assumed that the smokestack criterion information is β1. Further, it is assumed that smokestack shape information generated by the information generation unit 13 is β2.

In this case, the inclination detection unit 15 subtracts the smokestack criterion information β1 from the smokestack shape information β2 generated by the information generation unit 13, and derives (β2−β1) as inclination of the smokestack 500. Thereby, the inclination detection unit 15 is able to recognize that the smokestack 500 is inclined an angle of (β2−β1) relative to the smokestack criterion information. More specifically, for example, when the smokestack criterion information is the criterion information relating to a shape of the smokestack 500 at a time of placing the smokestack 500, the inclination detection unit 15 is able to recognize that the smokestack 500 has been inclined an angle of (β2−β1) from a time of placing the smokestack 500.

Note that, the inclination detection unit 15 may detect, as inclination of the smokestack 500, the very smokestack shape information β2 generated by the information generation unit 13.

The detection side communication unit 16 receives the smokestack shape information transmitted by the light source side communication unit 14. As described above, a communication between the detection side communication unit 16 and the light source side communication unit 14 is performed in a wired or wireless way.

The configuration of the smokestack inclination detection device 100 has been described above.

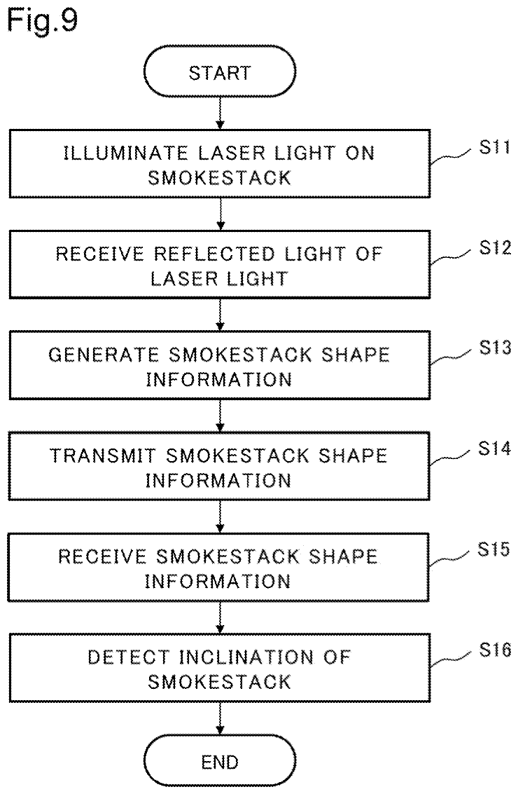

Next, an operation of the smokestack inclination detection system 1000 is described. FIG. 9 is a diagram illustrating an operation flow of the smokestack inclination detection system 1000.

Referring to FIG. 9, first, the light illumination unit 11 of the light source unit 200 illuminates laser light on the side surface 510 of the smokestack 500 (STEP (hereinafter, simply referred to as S) 11). In this instance, as described above, by rotating the mirror 220 about the central axis CL by driving of the drive unit 210, the light source unit 200 causes the laser light illuminated by the light illumination unit 11 to scan along an extension direction of the smokestack 500.

Next, the light receiving unit 12 receives reflected laser light from the side surface 510 of the smokestack 500 (S12). In this instance, light (reflected laser light) resulting from laser light that is caused to scan along an extension direction of the side surface 510 of the smokestack 500 and reflected by the side surface 510 of the smokestack 500 sequentially enters the light receiving unit 12.

The information generation unit 13 generates smokestack shape information, based on the reflected laser light received by the light receiving unit 12 (S13). More specifically, the information generation unit 13 generates a figure illustrated in FIG. 3, from a point cloud of a plurality of pieces of reflected laser light sequentially received by the light receiving unit 12, and a horizontal line (a line perpendicular to the vertical direction G). In other words, the information generation unit 13 calculates a distance up to the light source unit 200 and the side surface 510 of the smokestack 500, based on a time at which laser light in a single pulse form is caused to exit by the light illumination unit 11, a time at which reflected laser light in a single pulse form is received by the light receiving unit 12, and a light velocity. The information generation unit 13 draws a point cloud as illustrated in FIG. 3, based on a calculated value of a distance up to the light source unit 200 and the side surface 510 of the smokestack 500, and an exit angle of laser light to a horizontal surface. Then, the information generation unit 13 calculates an angle β formed between a straight line acquired by performing a regression analysis (linear regression or the like) of a line drawn with the point cloud, and the horizontal surface. In this way, the information generation unit 13 derives, from the figure illustrated in FIG. 3, an angle β between the side surface 510 of the smokestack 500, and a horizontal surface (a surface perpendicular to a vertical direction), and generates the angle β as smokestack shape information.

Thereby, the information generation unit 13 is able to generate smokestack shape information from a shape in an extension direction of the smokestack 500. Specifically, a shape of the side surface 510 of the smokestack 500 is planarly and two-dimensionally acquired, and smokestack shape information can be generated from the two-dimensional information.

The light source unit 200 is also able to cause the laser light illuminated by the light illumination unit 11 to scan along an extension direction of the smokestack 500 and a direction perpendicular to the extension direction of the smokestack 500. In this instance, referring to FIGS. 4 to 7, the mirror 220 can be moved in a direction perpendicular to the extension direction of the smokestack 500, by moving the rotation shaft 230 forward and backward along the central axis CL. Then, while the mirror 220 is rotated about the central axis CL by use of the drive unit 210, the mirror 220 is moved forward and backward along the central axis CL. Thereby, the laser light illuminated by the light illumination unit 11 is caused to scan along an extension direction of the smokestack 500 and a direction perpendicular to the extension direction of the smokestack 500. Light (reflected laser light) resulting from laser light that is caused to scan along an extension direction of the side surface 510 of the smokestack 500 and a direction perpendicular to the extension direction of the smokestack 500 and reflected by the side surface 510 of the smokestack 500 sequentially enters the light receiving unit 12.

In this case as well, the information generation unit 13 calculates a distance up to the light source unit 200 and the side surface 510 of the smokestack 500, based on a time at which laser light in a single pulse form is caused to exit by the light illumination unit 11, a time at which reflected laser light in a single pulse form is received by the light receiving unit 12, and a light velocity. The information generation unit 13 draws a point cloud, based on a calculated value of the distance up to the light source unit 200 and the side surface 510 of the smokestack 500, and an exit angle of laser light to a horizontal surface. In this instance, while the mirror 220 is rotated about the central axis CL by use of the drive unit 210, the mirror 220 is moved forward and backward along the central axis CL, and, therefore, the information generation unit 13 draws not the linear point cloud illustrated in FIG. 3, but an internal point cloud being associated with the side surface 510 of the smokestack 500. Then, the information generation unit 13 draws a curved surface acquired by performing a regression analysis (nonlinear regression or the like) of a curved surface drawn with the point cloud. Further, the information generation unit 13 derives a straight line formed when the drawn curved surface is cut in a surface perpendicular to the curved surface and parallel to the vertical direction G. The information generation unit 13 calculates an angle β between the derived straight line and a horizontal surface. In this way, the information generation unit 13 derives, from an internal point cloud being associated with the side surface 510 of the smokestack 500, an angle β between the side surface 510 of the smokestack 500, and a horizontal surface (a surface perpendicular to a vertical direction), and generates the angle β as smokestack shape information.

Thereby, the information generation unit 13 is able to generate smokestack shape information from a shape formed by a point cloud acquired by reflected laser light from the smokestack 500. Specifically, the information generation unit 13 is able to cubically and three-dimensionally acquire a shape of the side surface 510 of the smokestack 500, and generate smokestack shape information from the three-dimensional information.

The light source side communication unit 14 transmits, to the smokestack inclination detection device 100, the smokestack shape information generated by the information generation unit 13 (S14).

The detection side communication unit 16 receives the smokestack shape information transmitted by the light source side communication unit 14 (S15).

Then, the inclination detection unit 15 detects inclination of the smokestack 500, based on the smokestack shape information received by the detection side communication unit 16 (S16). In other words, the inclination detection unit 15 detects inclination of the smokestack 500, based on the smokestack shape information generated by the information generation unit 13.

The operation of the smokestack inclination detection system 1000 has been described above.

The smokestack inclination detection system 1000 according to the first example embodiment of the present invention includes the light source unit 200 and the smokestack inclination detection device 100. The light source unit 200 includes the light illumination unit 11, the light receiving unit 12, and the information generation unit 13. The smokestack inclination detection device 100 includes the inclination detection unit 15. The light illumination unit 11 illuminates laser light on the smokestack 500. The light receiving unit 12 receives reflected laser light. The reflected laser light is light resulting from laser light illuminated on the smokestack 500 and reflected by the smokestack 500. The information generation unit 13 generates smokestack shape information, based on the reflected laser light received by the light receiving unit 12. The smokestack shape information is information relating to a shape of a smokestack. The inclination detection unit 15 detects inclination of the smokestack, based on the smokestack shape information generated by the information generation unit 13.

In this way, in the smokestack inclination detection system 1000 according to the first example embodiment of the present invention, the information generation unit 13 generates smokestack shape information, based on the reflected laser light received by the light receiving unit 12. In other words, the information generation unit 13 generates, as smokestack shape information, information relating to a shape of a smokestack. Then, the inclination detection unit 15 detects inclination of the smokestack, based on the smokestack shape information generated by the information generation unit 13. In other words, the inclination detection unit 15 is able to detect, from the very the smokestack shape information, an angle formed by a side surface of the smokestack 500 and a horizontal surface (a surface perpendicular to the vertical direction G), as inclination of the smokestack 500. Alternatively, the inclination detection unit 15 is able to detect a change of an angle formed by a side surface of the smokestack 500 and the horizontal surface, as inclination of the smokestack 500.

As described above, the smokestack inclination detection system 1000 according to the first example embodiment of the present invention is able to detect inclination of the smokestack 500.

In the smokestack inclination detection system 1000 according to the first example embodiment of the present invention, the inclination detection unit 15 may detect inclination of the smokestack 500, based on smokestack shape information generated by the information generation unit 13, and smokestack criterion information. Herein, the smokestack criterion information is criterion information relating to a shape of a smokestack. For example, it is assumed that the smokestack criterion information is β1. Further, it is assumed that smokestack shape information generated by the information generation unit 13 is β2. In this case, the inclination detection unit 15 is able to subtract the smokestack criterion information β1 from the smokestack shape information β2 generated by the information generation unit 13, and derive (β2−β1) as inclination of the smokestack 500.

Thereby, the smokestack inclination detection system 1000 is able to detect a change of smokestack shape information. In other words, the smokestack inclination detection system 1000 is able to detect how much smokestack shape information has changed from smokestack criterion information. More specifically, in the above-described example, the smokestack inclination detection system 1000 is able to recognize that the smokestack 500 is inclined an angle of (β2−β1) relative to the smokestack criterion information. For example, when smokestack criterion information is criterion information relating to a shape of the smokestack 500 at a time of initially placing the smokestack 500, the smokestack inclination detection system 1000 is able to recognize that the smokestack 500 has been inclined an angle of (β2−β1) from the time of placing the smokestack 500.

In the smokestack inclination detection system 1000 according to the first example embodiment of the present invention, laser light is caused to scan along an extension direction of the smokestack 500. Thereby, the information generation unit 13 is able to generate smokestack shape information from a shape in the extension direction of the smokestack 500. More specifically, the information generation unit 13 is able to planarly and two-dimensionally acquire a shape of the side surface 510 of the smokestack 500, and generate smokestack shape information from the two-dimensional information.

In the smokestack inclination detection system 1000 according to the first example embodiment of the present invention, laser light is caused to scan along an extension direction of the smokestack 500 and a direction perpendicular to the extension direction. Thereby, the information generation unit 13 is able to acquire, as smokestack shape information, shapes in the extension direction of the smokestack 500 and the direction perpendicular to the extension direction. Specifically, the information generation unit 13 is able to cubically and three-dimensionally acquire a shape of the side surface 510 of the smokestack 500, and generate smokestack shape information from the three-dimensional information.

A smokestack inclination detection method according to the first example embodiment of the present invention includes at least an information generation step and a smokestack inclination detection step. In the information generation step, smokestack shape information is generated based on reflected laser light. The smokestack shape information is information relating to a shape of a smokestack. In the smokestack inclination detection step, inclination of the smokestack 500 is detected based on the smokestack shape information. Herein, the reflected laser light is light resulting from laser light illuminated on the smokestack 500 and reflected by the smokestack 500. Such a smokestack inclination detection method can also provide an effect similar to that of the above-described smokestack inclination detection system 1000.

A smokestack inclination detection program according to the first example embodiment of the present invention causes a computer to execute processing including the information generation step and the smokestack inclination detection step. Such a smokestack inclination detection program can also provide an effect similar to that of the above-described smokestack inclination detection system 1000.

A storage medium according to the first example embodiment of the present invention is a computer-readable recording medium recording the smokestack inclination detection program. Such a storage medium can also provide an effect similar to that of the above-described smokestack inclination detection system 1000.

### Second Operation Example of the Smokestack Inclination Detection System 1000 According to the First Example Embodiment of the Present Invention

Next, a second operation example of the smokestack inclination detection system 1000 according to the first example embodiment of the present invention is described.

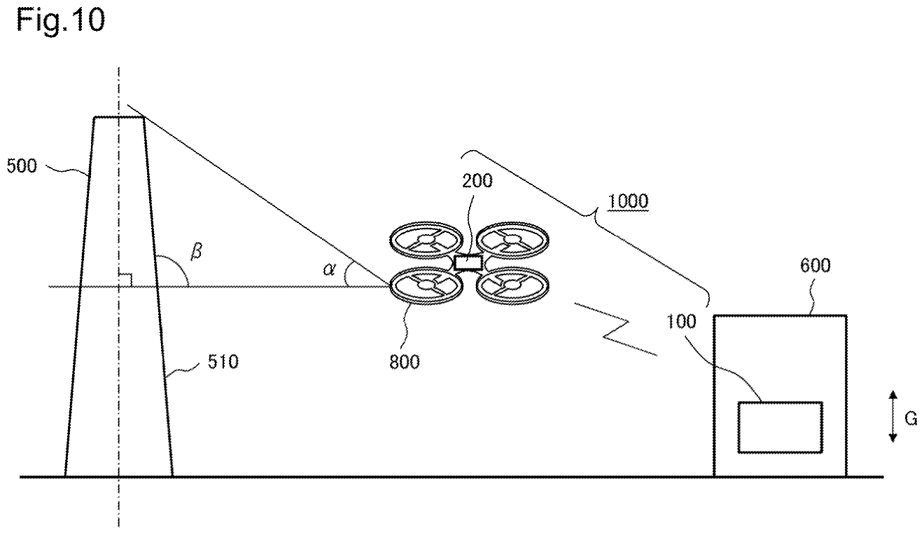

FIG. 10 is a schematic diagram illustrating the second operation example of the smokestack inclination detection system 1000. The vertical direction G is indicated in FIG. 10.

Herein, FIGS. 2 and 10 are compared. In FIG. 2, the light source unit 200 is mounted on the support 700. In contrast, in FIG. 10, the light source unit 200 is mounted on an aircraft 800. In this point, the two figures differ from each other.

The aircraft 800 is an airplane, a rotary-wing aircraft (a helicopter or the like), or an airship, and may be either manned or unmanned. The aircraft 800 may be a drone. A drone is an unmanned aircraft being capable of remote piloting or autonomous flight, and is also referred to as an unmanned aerial vehicle (UAV) or an unmanned aircraft system (UAS).

The aircraft 800 includes a gyro mechanism. The aircraft 800 is able to stably bring, by use of the gyro mechanism, a body to a standstill along a horizontal surface being a surface perpendicular to the vertical direction G.

Then, an attitude of the aircraft 800 is maintained in such a way that the central axis CL of the light source unit 200 is arranged perpendicular to the vertical direction G. Thereby, regarding each part inside the light source unit 200, the same arrangement relation as that in the first operation example of the smokestack inclination detection system 1000 can be achieved. In other words, the central axis CL is set perpendicular to the vertical direction G. As described by use of FIG. 4, in initial setting, the reflection surface 220a of the mirror 220 is set in such a way as to reflect, in a direction perpendicular to the vertical direction G, laser light illuminated by the light illumination unit 11. Similarly, in initial setting, the reflection surface 220a of the mirror 220 is set in such a way that reflected laser light from the side surface 510 of the smokestack 500 enters in a direction perpendicular to the vertical direction G. Specifically, the arrangement relations are set by control of an attitude of the aircraft 800.

It has been described above that the light source unit 200 is mounted on the aircraft 800. However, the light source unit 200 is not limited to be mounted on the aircraft 800, and may be provided in a movable body. For example, the light source unit 200 may be provided in a box, such as a lift or a gondola, suspended by a string in air, and raised or lowered along the vertical direction G.

The configuration and operation of each unit of the smokestack inclination detection system 1000 are as described in the first example embodiment.

As described above, in the smokestack inclination detection system 1000 according to the first example embodiment of the present invention, the light illumination unit 11 and the light receiving unit 12 are installed on a movable body. Thereby, while the light illumination unit 11 and the light receiving unit 12 are moved, inclination of the smokestack 500 can be detected.

### Second Example Embodiment

Next, a smokestack inclination detection system 1000A according to a second example embodiment of the present invention is described.

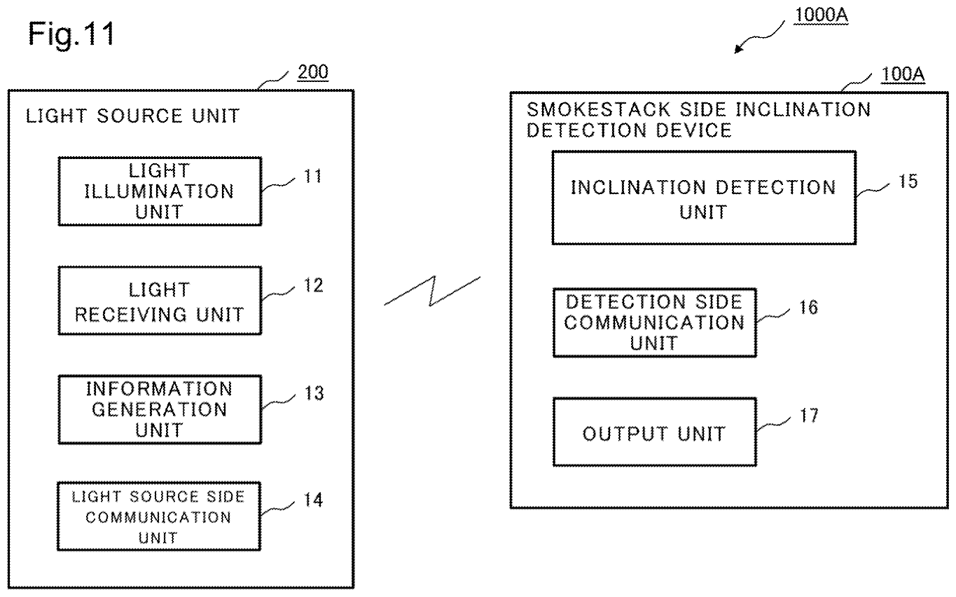

FIG. 11 is a block diagram illustrating a configuration of the smokestack inclination detection system 1000A. Referring to FIG. 11, the smokestack inclination detection system 1000A includes a smokestack inclination detection device 100A and a light source unit 200. The smokestack inclination detection device 100A includes an inclination detection unit 15, a detection side communication unit 16, and an output unit 17. The light source unit 200 includes a light illumination unit 11, a light receiving unit 12, an information generation unit 13, and a light source side communication unit 14.

Herein, FIGS. 1 and 11 are compared. In FIG. 1, the smokestack inclination detection device 100 does not include the output unit 17. In contrast, in FIG. 11, the smokestack inclination detection device 100A includes the output unit 17. In this point, the two figures differ from each other.

The output unit 17 outputs information relating to inclination of a smokestack 500. Herein, the information relating to inclination of the smokestack 500 is information of an angle formed by a side surface of the smokestack 500 and a surface perpendicular to a vertical direction G, or information of a change of an angle formed by a side surface of the smokestack 500 and a surface perpendicular to the vertical direction G. As described above, inclination of the smokestack 500 is detected by the inclination detection unit 15. The output unit 17 is a display device, a speaker device, or the like, and outputs, by a video or a sound, information relating to inclination of the smokestack 500.

Components other than the output unit 17 are as described in the first example embodiment.

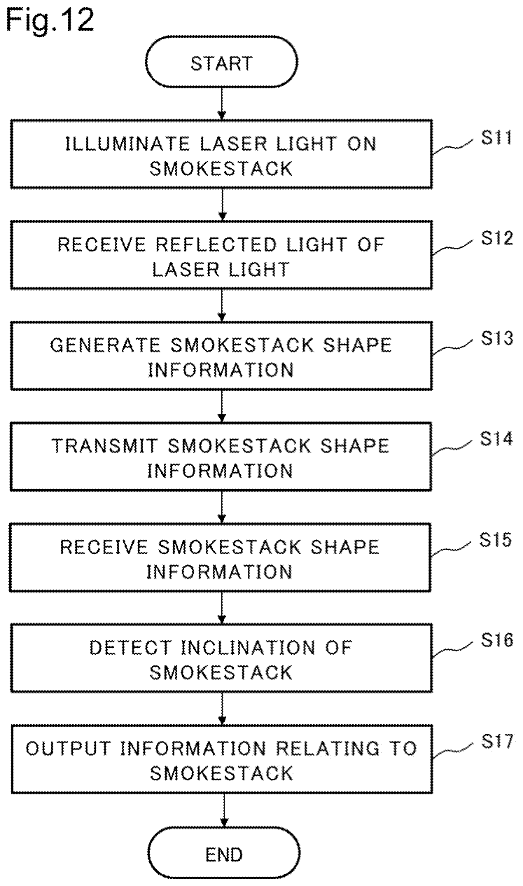

Next, an operation of the smokestack inclination detection system 1000A is described. FIG. 12 is a diagram illustrating an operation flow of the smokestack inclination detection system 1000A.

Herein, FIGS. 9 and 12 are compared. FIG. 12 differs from FIG. 9 in including S17.

Referring to FIG. 12, first, the light illumination unit 11 of the light source unit 200 illuminates laser light on a side surface 510 of the smokestack 500 (S11). Next, the light receiving unit 12 receives reflected laser light from the side surface 510 of the smokestack 500 (S12). The information generation unit 13 generates smokestack shape information, based on the reflected laser light received by the light receiving unit 12 (S13). The light source side communication unit 14 transmits, to the smokestack inclination detection device 100, the smokestack shape information generated by the information generation unit 13 (S14). The detection side communication unit 16 receives the smokestack shape information transmitted by the light source side communication unit 14 (S15). The inclination detection unit 15 detects inclination of the smokestack 500, based on the smokestack shape information received by the detection side communication unit 16 (S16). Specific processing in S11 to S16 is similar to a content described by use of FIG. 9. Next, the output unit 17 outputs information relating to inclination of the smokestack 500 detected by the inclination detection unit 15 (S17). The output unit 17 is a display device, a speaker device, or the like, and outputs, by a video or a sound, information relating to inclination of the smokestack 500.

The operation of the smokestack inclination detection system 1000A has been described above.

In the smokestack inclination detection system 1000A according to the second example embodiment of the present invention, the output unit 17 outputs information relating to inclination of the smokestack 500 detected by the inclination detection unit 15. Thereby, information relating to inclination of the smokestack 500 can be reported to a manager or a person concerned of the smokestack inclination detection system 1000A.

In the smokestack inclination detection system 1000A according to the second example embodiment of the present invention, the output unit 17 may output a fact that inclination of the smokestack 500 is caused, based on a degree of inclination of the smokestack 500 detected by the inclination detection unit 15. In other words, a threshold value is set in advance regarding inclination of the smokestack 500 detected by the inclination detection unit 15. Then, the output unit 17 determines whether the degree of inclination of the smokestack 500 detected by the inclination detection unit 15 is greater than the threshold value. When the degree of inclination of the smokestack 500 detected by the inclination detection unit 15 is greater than the threshold value, the output unit 17 determines that inclination of the smokestack 500 is caused. Then, the output unit 17 outputs a result of the determination that inclination of the smokestack 500 is caused. Thereby, a fact that inclination of the smokestack 500 is caused can be reported to a manager or a person concerned of the smokestack inclination detection system 1000A.

### Third Example Embodiment

Next, a smokestack inclination detection device 100B according to a third example embodiment of the present invention is described.

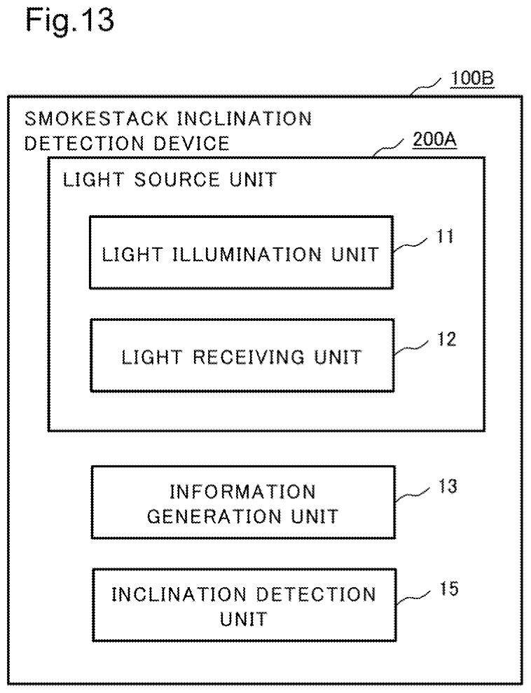

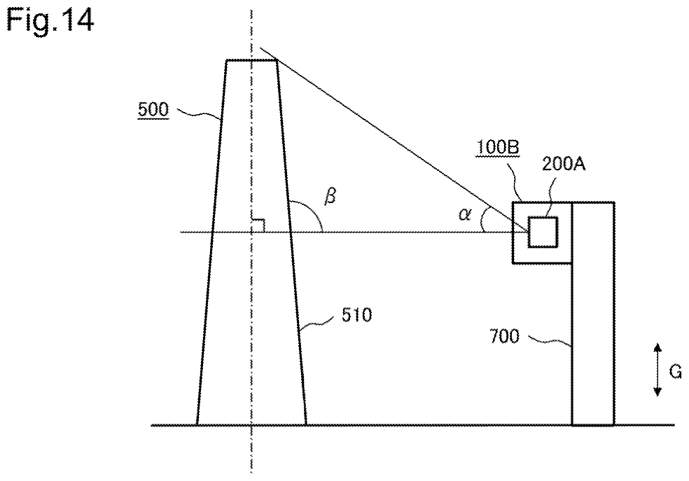

FIG. 13 is a block diagram illustrating a configuration of the smokestack inclination detection device 100B. FIG. 14 is a schematic diagram illustrating an operation example of the smokestack inclination detection device 100B. A vertical direction G is indicated in FIG. 14.

Herein, FIGS. 2 and 14 are compared. In FIG. 2, the light source unit 200 and the smokestack inclination detection device 100 are separately configured. Then, the light source unit 200 is placed on the support 700, and the smokestack inclination detection device 100 is placed in the data center 600. In contrast, in FIG. 14, the smokestack inclination detection device 100B includes a light source unit 200A. The smokestack inclination detection device 100B is placed on the support 700 in a form of including the light source unit 200A.

Referring to FIGS. 13 and 14, the smokestack inclination detection device 100B includes the light source unit 200A, an information generation unit 13, and an inclination detection unit 15. The light source unit 200A includes a light illumination unit 11 and a light receiving unit 12.

Herein, FIGS. 1 and 13 are compared. In FIG. 1, the light source unit 200 and the smokestack inclination detection device 100 are separately configured, and communicate with each other by use of the light source side communication unit 14 and the detection side communication unit 16. In contrast, in FIG. 13, the smokestack inclination detection device 100B includes the light source unit 200A. Thus, in FIG. 13, unlike FIG. 1, the smokestack inclination detection device 100B does not include the light source side communication unit 14 and the detection side communication unit 16.

The light illumination unit 11 illuminates laser light on a side surface 510 of a smokestack 500. The light receiving unit 12 receives light (reflected laser light) resulting from laser light illuminated on the smokestack 500 and reflected by the smokestack 500. The information generation unit 13 generates smokestack shape information, based on the reflected laser light received by the light receiving unit 12. The inclination detection unit 15 detects inclination of the smokestack 500, based on the smokestack shape information generated by the information generation unit 13. Each of functions of the light illumination unit 11, the light receiving unit 12, the information generation unit 13, and the inclination detection unit 15 is similar to a content described in the first example embodiment. A physical structure of the light source unit 200A is similar to a physical structure of the light source unit 200 according to the first example embodiment.

The configuration of the smokestack inclination detection device 100B has been described above.

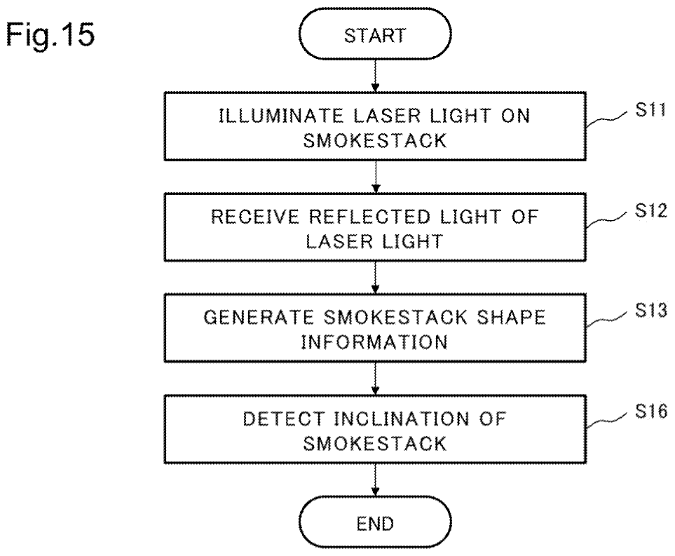

Next, an operation of the smokestack inclination detection device 100B is described. FIG. 15 is a diagram illustrating an operation flow of the smokestack inclination detection device 100B.

Herein, FIGS. 9 and 15 are compared. FIG. 15 differs from FIG. 9 in not including S14 and S15.

Referring to FIG. 15, first, the light illumination unit 11 of the light source unit 200A illuminates laser light on the side surface 510 of the smokestack 500 (S11). Next, the light receiving unit 12 receives reflected laser light from the side surface 510 of the smokestack 500 (S12). The information generation unit 13 generates smokestack shape information, based on the reflected laser light received by the light receiving unit 12 (S13). The inclination detection unit 15 detects inclination of the smokestack 500, based on the smokestack shape information received by the light receiving unit 12 (S16). Specific processing in S11 to S13 and S16 is similar to a content described by use of FIG. 9.

The operation of the smokestack inclination detection device 100B has been described above.

As described above, the smokestack inclination detection device 100B according to the third example embodiment of the present invention includes the light illumination unit 11, the light receiving unit 12, the information generation unit 13, and the inclination detection unit 15. The light illumination unit 11 illuminates laser light on the smokestack 500. The light receiving unit 12 receives reflected laser light. The reflected laser light is light resulting from laser light illuminated on the smokestack 500 and reflected by the smokestack 500. The information generation unit 13 generates smokestack shape information, based on the reflected laser light. The smokestack shape information is information relating to a shape of the smokestack 500. The inclination detection unit 15 detects inclination of the smokestack 500, based on the smokestack shape information generated by the information generation unit 13.

Such a configuration can also provide an effect similar to that of the smokestack inclination detection system 1000 according to the first example embodiment.

### Fourth Example Embodiment

Next, a smokestack inclination detection device 100C according to a fourth example embodiment of the present invention is described.

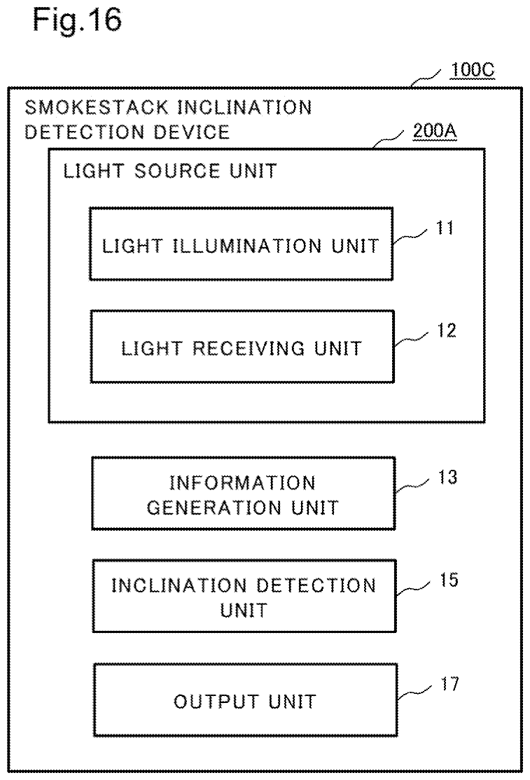

FIG. 16 is a block diagram illustrating a configuration of the smokestack inclination detection device 100C. Referring to FIG. 16, the smokestack inclination detection device 100C includes a light source unit 200A, an information generation unit 13, an inclination detection unit 15, and an output unit 17. The light source unit 200A includes a light illumination unit 11 and a light receiving unit 12.

Herein, FIGS. 13 and 16 are compared. In FIG. 13, the smokestack inclination detection device 100B does not include the output unit 17. In contrast, in FIG. 16, the smokestack inclination detection device 100C includes the output unit 17. In this point, the two figures differ from each other.

The output unit 17 outputs information relating to inclination of a smokestack 500 detected by the inclination detection unit 15. Herein, the information relating to inclination of the smokestack 500 is information of an angle formed by a side surface of the smokestack 500 and a surface perpendicular to a vertical direction G, or information of a change of an angle formed by a side surface of the smokestack 500 and a surface perpendicular to the vertical direction G. The output unit 17 is a display device, a speaker device, or the like, and outputs, by a video or a sound, information relating to inclination of the smokestack 500.

Components other than the output unit 17 are as described in the first example embodiment.

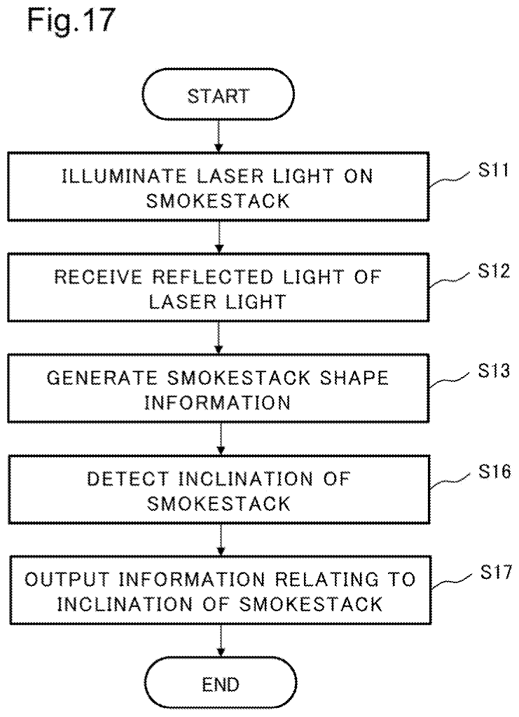

Next, an operation of the smokestack inclination detection device 100C is described. FIG. 17 is a diagram illustrating an operation flow of the smokestack inclination detection device 100C.

Herein, FIGS. 15 and 17 are compared. FIG. 17 differs from FIG. 15 in including S17.

Referring to FIG. 17, first, the light illumination unit 11 of the light source unit 200A illuminates laser light on the side surface 510 of the smokestack 500 (S11). Next, the light receiving unit 12 receives reflected laser light from the side surface 510 of the smokestack 500 (S12). The information generation unit 13 generates smokestack shape information, based on the reflected laser light received by the light receiving unit 12 (S13). The inclination detection unit 15 detects inclination of the smokestack 500, based on the smokestack shape information received by the light receiving unit 12 (S16). Next, the output unit 17 outputs information relating to inclination of the smokestack 500 detected by the inclination detection unit 15 (S17). The output unit 17 is a display device, a speaker device, or the like, and outputs, by a video or a sound, information relating to inclination of the smokestack 500. Specific processing in S11 to S13 and S16 is similar to a content described by use of FIG. 9.

The operation of the smokestack inclination detection device 100C has been described above.

In the smokestack inclination detection device 100C according to the fourth example embodiment of the present invention, the output unit 17 outputs information relating to inclination of the smokestack 500 detected by the inclination detection unit 15. Thereby, information relating to inclination of the smokestack 500 can be reported to a manager or a person concerned of the smokestack inclination detection device 100C.

In the smokestack inclination detection device 100C according to the fourth example embodiment of the present invention, the output unit 17 may output a fact that inclination of the smokestack 500 is caused, based on a degree of inclination of the smokestack 500 detected by the inclination detection unit 15. In other words, a threshold value is set in advance regarding inclination of the smokestack 500 detected by the inclination detection unit 15. Then, the output unit 17 determines whether the degree of inclination of the smokestack 500 detected by the inclination detection unit 15 is greater than the threshold value. When the degree of inclination of the smokestack 500 detected by the inclination detection unit 15 is greater than the threshold value, the output unit 17 determines that inclination of the smokestack 500 is caused. Then, the output unit 17 outputs a result of the determination that inclination of the smokestack 500 is caused. Thereby, a fact that inclination of the smokestack 500 is caused can be reported to a manager or a person concerned of the smokestack inclination detection device

### Fifth Example Embodiment

Next, a smokestack inclination detection device 100D according to a fifth example embodiment of the present invention is described. One specific example of the smokestack inclination detection device 100D is the above-described smokestack inclination detection device 100, 100A, 100B, or 100C.

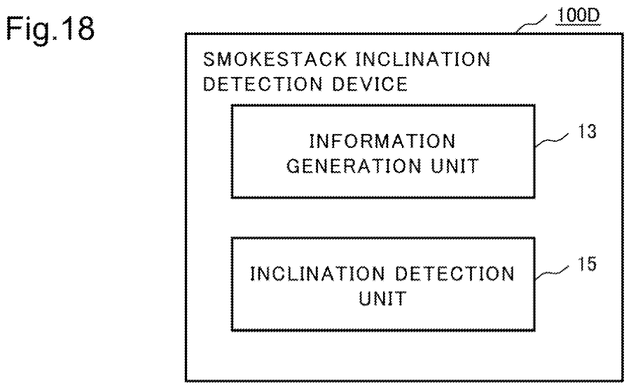

FIG. 18 is a block diagram illustrating a configuration of the smokestack inclination detection device 100D. Referring to FIG. 18, the smokestack inclination detection device 100D includes an information generation unit 13 and an inclination detection unit 15.

Herein, FIGS. 13 and 18 are compared. In FIG. 13, the smokestack inclination detection device 100B includes the light source unit 200A. In contrast, in FIG. 18, the smokestack inclination detection device 100D does not include the light source unit 200A. In this point, the two figures differ from each other.

The information generation unit 13 generates smokestack shape information, based on the reflected laser light. The reflected laser light is light resulting from laser light illuminated on a smokestack and reflected by the smokestack. The smokestack shape information is information relating to a shape of the smokestack. The inclination detection unit 15 detects inclination of the smokestack, based on the smokestack shape information generated by the information generation unit 13.

The configuration of the smokestack inclination detection device 100D has been described above.

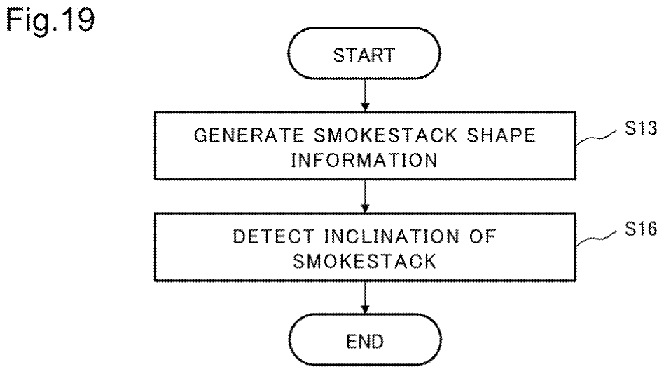

Next, an operation of the smokestack inclination detection device 100D is described. FIG. 19 is a diagram illustrating an operation flow of the smokestack inclination detection device 100D.

Herein, FIGS. 15 and 19 are compared. FIG. 15 differs from FIG. 19 in including S11 and S12.

Referring to FIG. 19, the information generation unit 13 generates smokestack shape information, based on reflected laser light (S13). The reflected laser light is light resulting from laser light illuminated on a smokestack and reflected by the smokestack. The smokestack shape information is information relating to a shape of the smokestack. The inclination detection unit 15 detects inclination of the smokestack 500, based on smokestack shape information generated by the information generation unit 13 (S16). Specific processing in S13 and S16 is similar to a content described by use of FIG. 9.

The operation of the smokestack inclination detection device 100D has been described above.

As described above, the smokestack inclination detection device 100D according to the fifth example embodiment of the present invention includes the information generation unit 13 and the inclination detection unit 15. The information generation unit 13 generates smokestack shape information, based on the reflected laser light. The reflected laser light is light resulting from laser light illuminated on a smokestack and reflected by the smokestack. The smokestack shape information is information relating to a shape of the smokestack. The inclination detection unit 15 detects inclination of the smokestack, based on the smokestack shape information generated by the information generation unit 13.

In this way, the inclination detection unit 15 detects inclination of a smokestack, based on smokestack shape information generated by the information generation unit 13. In other words, for example, the inclination detection unit 15 is able to detect, from the very smokestack shape information, an angle formed by a side surface of a smokestack and a surface perpendicular to a vertical direction, as inclination of the smokestack. Alternatively, for example, the inclination detection unit 15 is able to detect a change of an angle formed by a side surface of a smokestack and a surface perpendicular to a vertical direction, as inclination of the smokestack.

As described above, the smokestack inclination detection device 100D according to the fifth example embodiment of the present invention is able to detect inclination of a smokestack.

Some or all of the above-described example embodiments can also be described as, but are not limited to, the following supplementary notes.

### (Supplementary Note 1)

A smokestack inclination detection device including:

an information generation unit that generates smokestack shape information being information relating to a shape of a smokestack, based on reflected laser light being light resulting from laser light illuminated on the smokestack and reflected by the smokestack; and

an inclination detection unit that detects inclination of the smokestack, based on the smokestack shape information generated by the information generation unit.

### (Supplementary Note 2)

The smokestack inclination detection device according to supplementary note 1, wherein the information generation unit generates, as the smokestack shape information, an angle formed by a side surface of the smokestack and a surface perpendicular to a vertical direction.

### (Supplementary Note 3)

The smokestack inclination detection device according to supplementary note 1 or 2, wherein the inclination detection unit detects inclination of the smokestack, based on the smokestack shape information generated by the information generation unit, and smokestack criterion information being criterion information relating to a shape of the smokestack.

### (Supplementary Note 4)

The smokestack inclination detection device according to any one of supplementary notes 1 to 3, wherein the laser light is caused to scan along an extension direction of the smokestack.

(Supplementary Note 5) The smokestack inclination detection device according to any one of supplementary notes 1 to 3, wherein the laser light is caused to scan along an extension direction of the smokestack and a direction perpendicular to the extension direction.

### (Supplementary Note 6)

The smokestack inclination detection device according to any one of supplementary notes 1 to 5, further including:

a light illumination unit that illuminates the laser light on the smokestack; and

a light receiving unit that receives the reflected laser light, wherein

the information generation unit generates the smokestack shape information, based on the reflected laser light received by the light receiving unit.

### (Supplementary Note 7)

The smokestack inclination detection device according to any one of supplementary notes 1 to 6, further including an output unit that outputs information relating to inclination of the smokestack being detected by the inclination detection unit.

### (Supplementary Note 8)

The smokestack inclination detection device according to supplementary note 7, wherein the output unit outputs a fact that inclination of the smokestack is caused, based on a degree of inclination of the smokestack being detected by the inclination detection unit.

### (Supplementary Note 9)

The smokestack inclination detection device according to any one of supplementary notes 6 to 8, wherein the light illumination unit and the light receiving unit are installed on a movable body.

### (Supplementary Note 10)

A smokestack inclination detection system including a light source unit and a smokestack inclination detection device, wherein

the light source unit includes
a light illumination unit that illuminates laser light on a smokestack,
a light receiving unit that receives reflected laser light being light resulting from the laser light reflected by the smokestack, and
an information generation unit that generates smokestack shape information being information relating to a shape of the smokestack, based on reflected light of the laser light being received by the light receiving unit, and

the smokestack inclination detection device includes
an inclination detection unit that detects inclination of the smokestack, based on the smokestack shape information generated by the information generation unit.

### (Supplementary Note 11)

A smokestack inclination detection method including:

generating smokestack shape information being information relating to a shape of a smokestack, based on reflected laser light being light resulting from laser light illuminated on the smokestack and reflected by the smokestack; and

detecting inclination of the smokestack, based on the smokestack shape information.

### (Supplementary Note 12)

A smokestack inclination detection program causing a computer to execute processing including:

an information generation step of generating smokestack shape information being information relating to a shape of a smokestack, based on reflected laser light being light resulting from laser light illuminated on the smokestack and reflected by the smokestack; and

a smokestack inclination detection step of detecting inclination of the smokestack, based on the smokestack shape information.

### (Supplementary Note 13)

A computer-readable recording medium recording the smokestack inclination detection program according to supplementary note 12.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-047228, filed on Mar. 18, 2020, the disclosure of which is incorporated herein in its entirety by reference.

### REFERENCE SIGNS LIST

11 Light illumination unit

12 Light receiving unit

13 Information generation unit

14 Light source side communication unit

15 Inclination detection unit

16 Detection side communication unit

100, 100A, 100B, 100C, 100D Smokestack inclination detection device

200, 200A Light source unit

210 Drive unit

220 Mirror

220a Reflection surface

230 Rotation shaft

240 Housing

500 Smokestack

510 Side surface

600 Data center

700 Support

800 Aircraft

1000, 1000A Smokestack inclination detection system

What is claimed is:

1. A smokestack inclination detection device comprising:
an information generator configured to generate smokestack shape information being information relating to a shape of a smokestack, based on reflected laser light being light resulting from laser light illuminated on the smokestack and reflected by the smokestack; and
an inclination detector configured to detect inclination of the smokestack, based on the smokestack shape information generated by the information generator.

2. The smokestack inclination detection device according to claim 1, wherein the information generator generates, as the smokestack shape information, an angle formed by a side surface of the smokestack and a surface perpendicular to a vertical direction.

3. The smokestack inclination detection device according to claim 1, wherein the inclination detector detects inclination of the smokestack, based on the smokestack shape information generated by the information generator, and smokestack criterion information being criterion information relating to a shape of the smokestack.

4. The smokestack inclination detection device according to claim 1, wherein the laser light is caused to scan along an extension direction of the smokestack.

5. The smokestack inclination detection device according to claim 1, wherein the laser light is caused to scan along an extension direction of the smokestack and a direction perpendicular to the extension direction.

6. The smokestack inclination detection device according to claim 1, further comprising:
an light illuminator configured to illuminate the laser light on the smokestack; and
an light receiver configured to receive the reflected laser light, wherein
the information generator configured to generate the smokestack shape information, based on the reflected laser light received by the light receiver.

7. The smokestack inclination detection device according to claim 1, further comprising an output portion configured to output information relating to inclination of the smokestack being detected by the inclination detector.

8. The smokestack inclination detection device according to claim 7, wherein the output portion outputs a fact that inclination of the smokestack is caused, based on a degree of inclination of the smokestack being detected by the inclination detector.

9. The smokestack inclination detection device according to claim 6, wherein the light illuminator illumination moans and the light receiver are installed on a movable body.

10. A smokestack inclination detection system comprising a light source and a smokestack inclination detection device, wherein
the light source includes
an light illuminator configures to illuminate laser light on a smokestack,
an light receiver configured to receive reflected laser light being light resulting from the laser light reflected by the smokestack, and
an information generator configured to generate smokestack shape information being information relating to a shape of the smokestack, based on reflected light of the laser light being received by the light receiver, and
the smokestack inclination detection device includes
an inclination detector configured to detect inclination of the smokestack, based on the smokestack shape information generated by the information generator.

11. (canceled)

12. A computer-readable recording medium recording a smokestack inclination detection program causing a computer to execute processing including:
an information generation step of generating smokestack shape information being information relating to a shape of a smokestack, based on reflected laser light being light resulting from laser light illuminated on the smokestack and reflected by the smokestack; and
a smokestack inclination detection step of detecting inclination of the smokestack, based on the smokestack shape information.
